(19) United States
(12) Patent Application Publication
(10) Pub. No.: US 2025/0024389 A1
(43) Pub. Date: Jan. 16, 2025

(54) SSB COVERAGE ENHANCEMENTS

(71) Applicant: Samsung Electronics Co., Ltd., Suwon-si (KR)

(72) Inventors: Mustafa Furkan Ozkoc, The Colony, TX (US); Jianhua Mo, Allen, TX (US); Young Han Nam, Plano, TX (US)

(21) Appl. No.: 18/763,988

(22) Filed: Jul. 3, 2024

Related U.S. Application Data
(60) Provisional application No. 63/526,617, filed on Jul. 13, 2023.

(51) Int. Cl. H04W 56/00; H04B 17/318; H04L 41/5009

(52) U.S. Cl. CPC H04W 56/0015; H04B 17/328; H04L 41/5009

(57) ABSTRACT

Apparatuses and methods for enhancing SSB coverage. A method performed by a base station includes transmitting, in a synchronization signal block (SSB) burst, a first SSB signal and one or more repetitions of the first SSB signal. The first SSB signal and the one or more repetitions of the first SSB signal are distinguished based on an indicative signal.

### CROSS-REFERENCE TO RELATED AND CLAIM OF PRIORITY

The present application claims priority under 35 U.S.C. § 119(e) to U.S. Provisional Patent Application No. 63/526,617 filed on Jul. 13, 2023, which is hereby incorporated by reference in its entirety.

### TECHNICAL FIELD

The present disclosure relates generally to wireless communication systems and, more specifically, the present disclosure is related to methods and apparatuses for enhancing synchronization signal block (SSB) coverage.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to methods and apparatuses for enhancing SSB coverage.

In one embodiment, a base station (BS) is provided. The BS includes a processor and a transceiver operably coupled to the processor. The transceiver is configured to transmit, in a SSB burst, a first SSB signal and one or more repetitions of the first SSB signal. The first SSB signal and the one or more repetitions of the first SSB signal are distinguished based on an indicative signal.

In another embodiment, a user equipment (UE) is provided. The UE includes a transceiver configured to receive one or more SSB signals. The UE further includes a processor operably coupled to the transceiver. The processor is configured to determine, based on an indicative signal, whether each of the one or more SSB signals is an original SSB signal or a repetition of the original SSB signal.

In yet another embodiment, a method performed by a base station is provided. The method includes transmitting, in a SSB burst, a first SSB signal and one or more repetitions of the first SSB signal. The first SSB signal and the one or more repetitions of the first SSB signal are distinguished based on an indicative signal.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example of a transmitter structure for beamforming according to embodiments of the present disclosure;

FIGS. 6 and 7 illustrate examples of narrow beam shapes according to embodiments of the present disclosure;

FIGS. 8 and 9 illustrate examples of wide beam patterns used in SSB transmission according to embodiments of the present disclosure;

FIG. 10 illustrates a diagram comparing effective power of SSB beam gains in two different systems according to embodiments of the present disclosure;

FIG. 11 illustrates an example of an SSB signal repetition order according to embodiments of the present disclosure;

FIG. 12 illustrates an example method performed by a UE in a wireless communication system according to embodiments of the present disclosure;

FIG. 13 illustrates an example method performed by the gNB for dynamically adjusting an SSB repetition order based on cell site key performance indicators (KPIs) according to embodiments of the present disclosure;

FIG. 14 illustrates an example method performed by the gNB for how a repetition order can be decided according to embodiments of the present disclosure; and

FIG. 15 illustrates an example of an SSB signal repetition order according to embodiments of the present disclosure.

### DETAILED DESCRIPTION

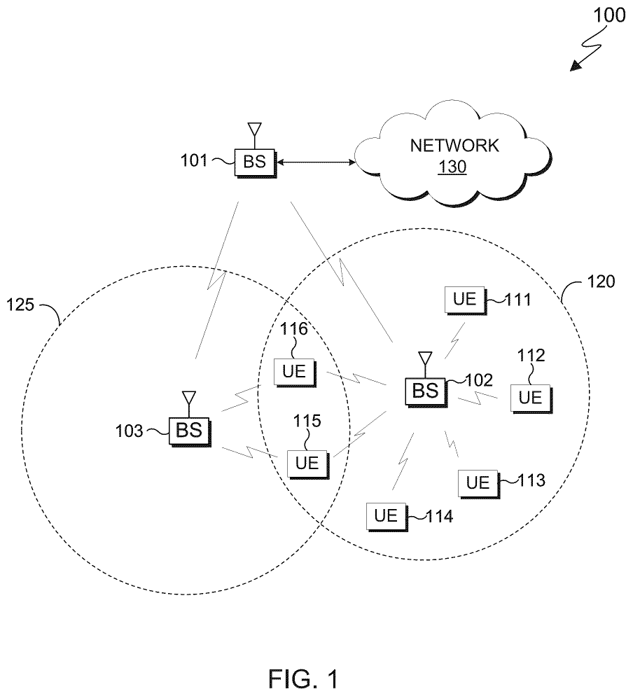

FIGS. 1-15 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of UEs within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for utilizing the enhanced SSB coverage. In certain embodiments, one or more of the BSs 101-103 include circuitry, programing, or a combination thereof to provide enhanced SSB coverage.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

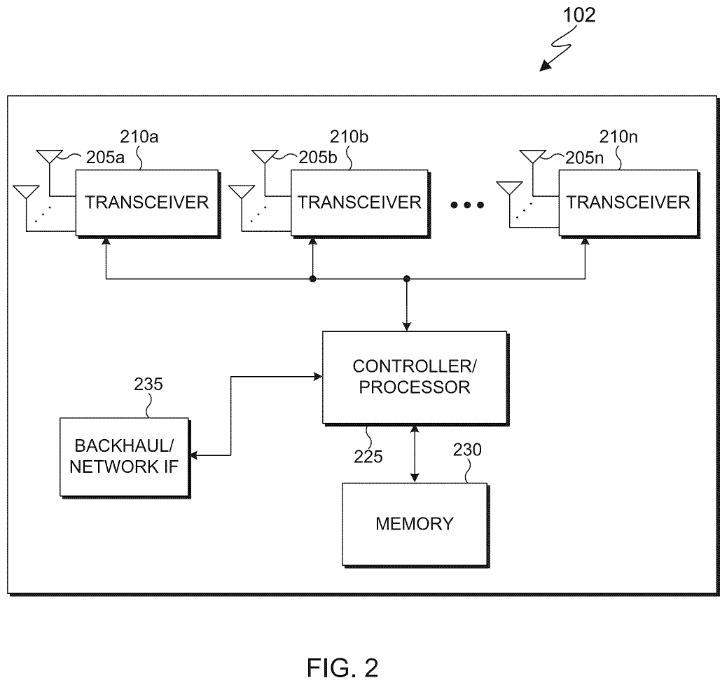

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of the present disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for enhancing SSB coverage. Any of a wide variety of other functions could be supported in the gNB 102 by the controller/processor 225.

The controller/processor 225 is also capable of executing programs and other processes resident in the memory 230, such as processes to enhance SSB coverage. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

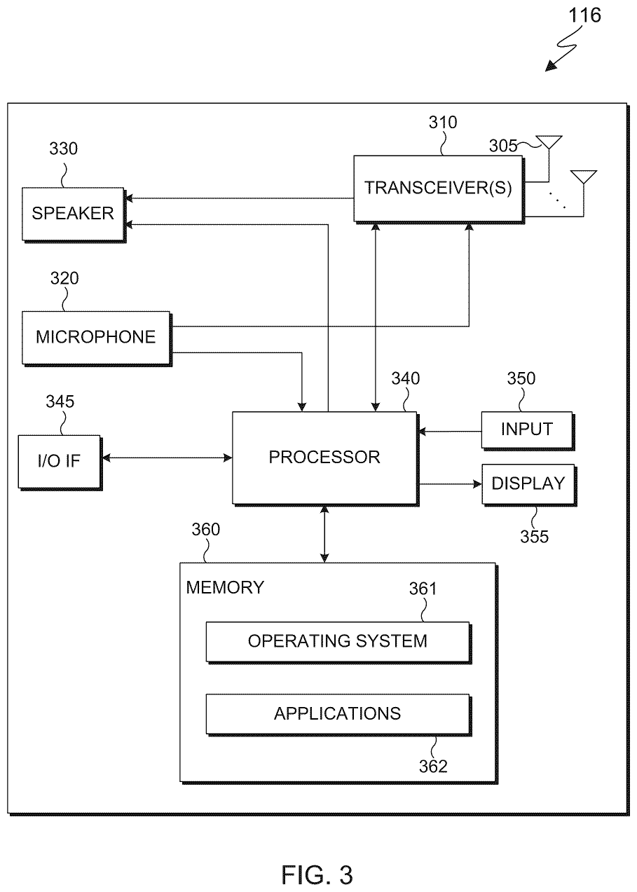

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing the enhanced SSB coverage as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

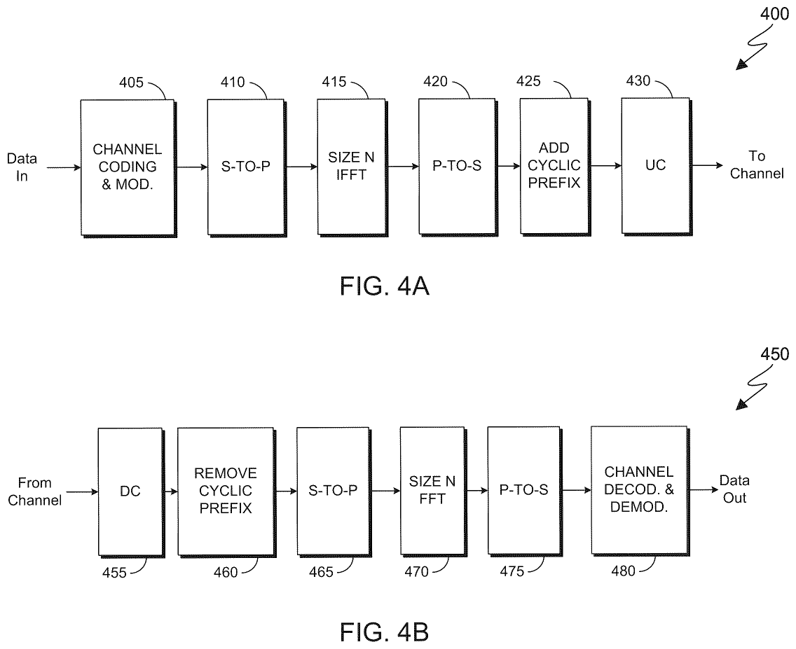

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 and/or the receive path 450 is configured for supporting the enhanced SSB coverage as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the gNBs 101-103 and may implement a receive path 450 for receiving in the downlink from the gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

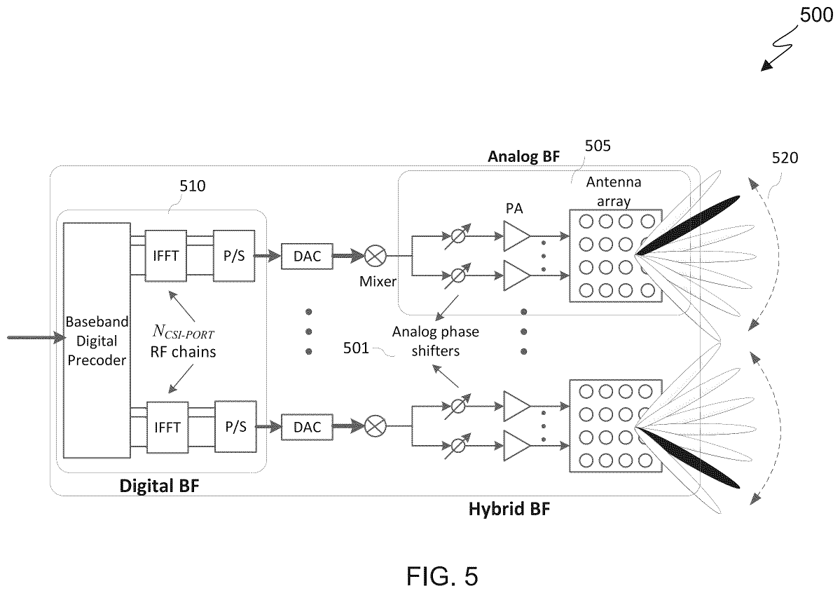

FIG. 5 illustrates an example of a transmitter structure 500 for beamforming according to embodiments of the present disclosure. In certain embodiments, one or more of gNB 102 or UE 116 includes the transmitter structure 500. For example, one or more of antenna 205 and its associated systems or antenna 305 and its associated systems can be included in transmitter structure 500. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 5. Then, one CSI-RS port can be mapped onto a large number of antenna elements that can be controlled by a bank of analog phase shifters 501. One CSI-RS port can then correspond to one sub-array which produces a narrow analog beam through analog beamforming 505. This analog beam can be configured to sweep across a wider range of angles 520 by varying the phase shifter bank across symbols or slots/subframes. The number of sub-arrays (equal to the number of RF chains) is the same as the number of CSI-RS ports N_{CSI-PORT}. A digital beamforming unit 510 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 500 of FIG. 5 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 5 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are essential to compensate for the additional path loss.

In the 5G-advanced or 6G communications, antenna arrays consisting of extremely large number of antenna elements (AEs)(e.g., N_{T}=3072) are expected to be used. Large number of AEs can be used to precode the signal in such a way that a large antenna array gain is achieved. The precoding creates a beam focusing the signal in a certain direction, where the gain is high in the regions inside the beam direction and low in the regions outside of the beam direction. As the number of AEs are increased, the peak beam gain is increased and the beam width is decreased. With large number of AEs in 5G-advanced and 6G communications, very sharp and very narrow beams will be used for data communication.

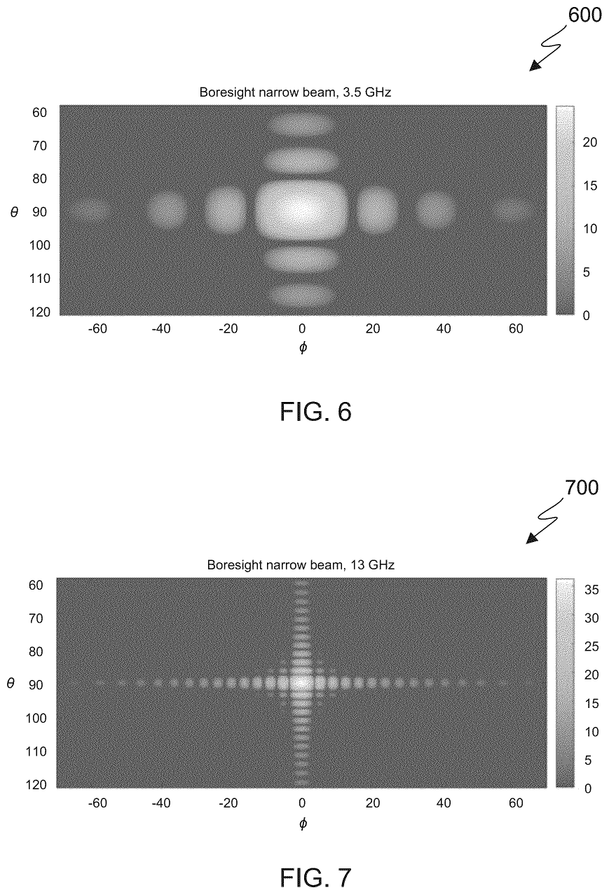

FIGS. 6 and 7 illustrate examples of narrow beam shapes 600 and 700 according to embodiments of the present disclosure. For example, narrow beam shapes 600 and 700 can be implemented by the gNB 102 of FIG. 2. These examples are for illustration only and can be used without departing from the scope of the present disclosure.

With reference to FIG. 6, a narrow beam being transmitted at 3.5 GHz with an example antenna array setup of 192 antennas is illustrated by the example narrow beam shape 600. With reference to FIG. 7, a narrow beam being transmitted at 13 GHz with an example antenna array setup of 3072 antennas is illustrated by the example narrow beam shape 700. As shown by these two figures, the narrow beam transmitted at 13 GHz is narrower in shape and has a significantly higher peak gain.

In 5G-NR systems, the beams used for SSB block transmission are typically referred as SSB beams and they are designed to be wider than the narrow beams. The SSB block transmission is expected to be present in the 5G-advanced or 6G communications systems, as well. The overall cell coverage over the sector is achieved by transmitting multiple SSB on different beams. Thus, the SSB beams should be designed such that the entire region can be covered by a few SSB beams. The width of the SSB beams must remain the same between two systems as the intended coverage region is the same and the number of SSBs are limited. The peak gain of an SSB beam is independent of NT but limited by the number of SSBs. As a result, the SSB gain remains the same between the smaller antenna arrays of 3.5 GHz and the larger antenna arrays of 5G-advanced or 6G.

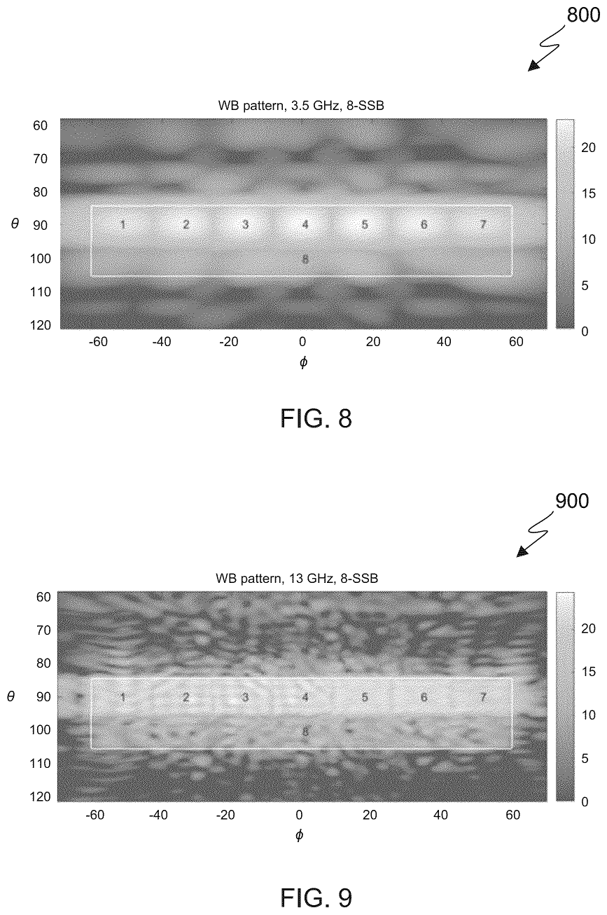

FIGS. 8 and 9 illustrate examples of wide beam patterns 800 and 900 used in SSB transmission according to embodiments of the present disclosure. For example, wide beam patterns 800 and 900 can be implemented by the gNB 102 of FIG. 2. These examples are for illustration only and can be used without departing from the scope of the present disclosure.

With reference to FIG. 8, an SSB beam being transmitted at 3.5 GHz with a codebook size of 8 is illustrated by the example wide beam pattern 800. With reference to FIG. 9, an SSB beam being transmitted at 13 GHz with a codebook size of 8 is illustrated by the example wide beam pattern 900. As shown by these two figures, the peak gains in each of the examples are close to each other.

In order to maximize the antenna array gain, during data transmission, the power amplifiers (PAs) could be configured such that when the narrow data beams are used, the effective, or equivalent, isotropically radiated power (EIRP) limit is met. When the SSB beams are transmitted in the same PA configurations, the equivalent radiated power is smaller due to different beam shapes of SSB beams and data beams. Previously, in 5G-NR, 3.5 GHz band, the beamforming gain difference between the data and SSB beams was small, typically 1-2 dB. Since decoding the SSB signals is easier than decoding the data signals, i.e., a smaller signal-to-noise (SNR) threshold for detection, the coverage range of SSB transmission and data transmission are consistent in 3.5 GHz systems when the gap between data and SSB beams are less than 1-2 dB. Table 1 provides typical beamforming gains for narrow beams and wide beams for a beam codebook design, that in this example, is an 8-SSB codebook.

TABLE 1
An example comparison of peak narrow
beam gain and peak wide beam gain.

| | Max Narrow Beam Gain | Max Wide (SSB) |
|---|---|---|
| | (4.5 + 10 log₁₀Nₐₙₜ) | Beam Gain |
| 3.5 GHz | 24.32 dB | 23.15 dB |
| 13 GHz | 36.36 dB | 24.39 dB |

The SSB signals are always on signals and their constant transmission creates an overhead in the system. Therefore, keeping the number of SSB signals and the number of SSB beams to cover the entire angular range as low as possible is desired. Typically, the number of SSBs are limited to 8, 32, or 64 depending on system configuration. In the 5G-advanced or 6G communications the gap between data and SSB beams can be upwards of 13 dB. The gain difference between narrow beams (NBs) and wide beams (WBs) are increased due to two factors. First, with higher number of AEs can create data beams with a significantly higher peak. Second, the SSB beam gain remains the same for a given codebook size.

Currently, the EIRP limit is expected to stay the same for the 5G-advanced or 6G communications. Therefore, the PAs are expected to be configured such that the EIRP limit for the data beams is met. Since the SSB beams and data beams have higher gain gap between them the equivalent radiated power of SSB beams will be even lower in these systems. This increased gap between the data and SSB beam radiated powers will lead to inconsistent coverage range between the data and SSB coverage, limiting SSB range significantly.

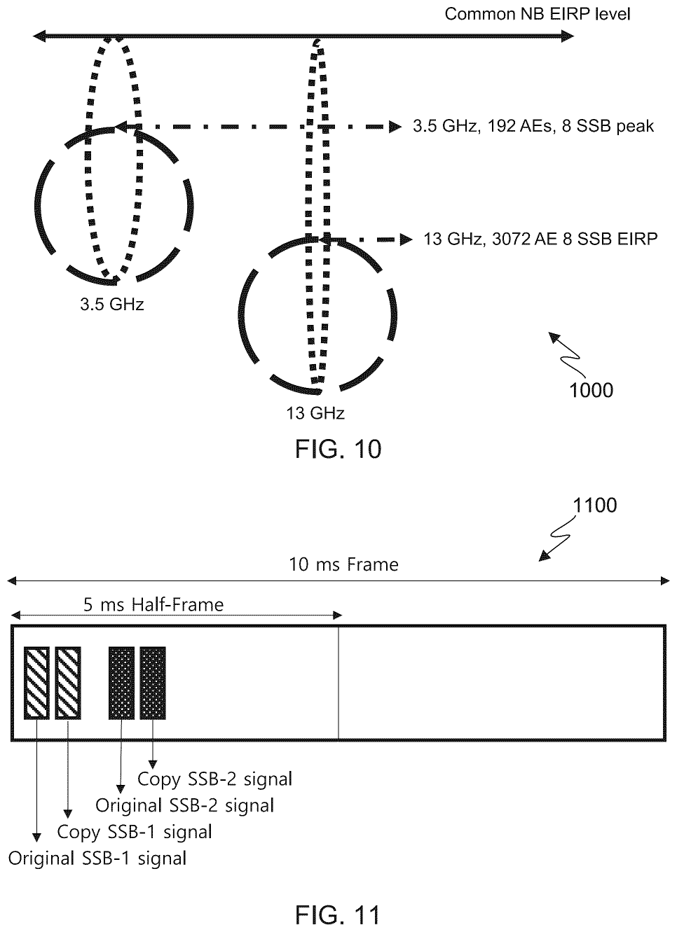

FIG. 10 illustrates a diagram 1000 comparing effective power of SSB beam gains in two different systems according to embodiments of the present disclosure. For example, the effective power of SSB beam gains shown in the diagram 1000 can be implemented by the gNB 102 of FIG. 2. This example is for illustration only and can be used without departing from the scope of the present disclosure.

As illustrated in FIG. 10, a comparison between of the effective power of SSB beam gains in a 3.5 GHz system and a 13 GHz system is provided. As shown by the figure, the effective power of SSB beam gains is much lower in one example of a 13 GHz system compared to one example of a 3.5 GHz system. As the gap between the narrow and wide beam gains are increased and the power of the SSB beams are reduced, the coverage range of SSB signals could be significantly reduced.

In one embodiment, the SSB coverage range can be increased using repetitive SSB block transmissions. The UE can receive multiple copies of the same SSB signal, combining the two (or more) received signals in order to improve the chance of decoding success. The system can be configured with different repetition order. In one example where original and a copy of SSB blocks are transmitted, i.e., one additional repetition, the UE can combine the two SSB blocks to increase the signal quality, therefore, successfully decoding the PSS/SSS signals within the SSB block. In one example, the decoding of the combined signal can be done successfully, even when the individual signal powers are 3 dB below the decoding threshold. The missing 3 dB SNR can be compensated by the combining gain, assuming a successful combination of the original and repeated SSB signal. With higher repetition orders and their combining, the SSB signals can be decoded even when there is more than 3 dB SNR missing. For example, 4 or 8 SSB combining systems can achieve 6 and 9 dB additional gain, respectively.

In 5G-advanced or 6G systems the SSB coverage could be the bottleneck. Increasing the number of SSBs could be a potential solution but it will result in additional interference both within the cell and to the neighboring cells. SSB repetition could be an alternative solution to increase SSB coverage without increasing the interference. SSB beam powers remain the same, but the SSB signals are transmitted multiple times using the same beam enabling combining over time. Therefore, signal power gain is achieved through combining without increasing the interference.

There could be multiple ways to enable SSB signal repetition. In one embodiment, the SSB blocks are sent in pairs where the first of the pair is the original immediately followed by the copy.

FIG. 11 illustrates an example of an SSB signal repetition order 1100 according to embodiments of the present disclosure. For example, the SSB signal repetition order 1100 can be implemented by the gNB 102 of FIG. 2. This example is for illustration only and can be used without departing from the scope of the present disclosure.

As illustrated in FIG. 11, an example of SSB signal repetition order 1100 for Case A, as defined in TS 38.213 Section 4.1 is provided. The provided example illustrates 4 SSB signals in one SSB block transmission. The 4 transmitted signals are two different SSB signals repeated one time each. In other SSB transmission cases, each odd numbered (2t−1) signal location in an SSB block can be occupied by the original SSB signal, and immediately following even numbered (2t) locations can be occupied by the copy SSB signal.

Other repetition methods could include but are not limited to:
i. block level repetition where in one SSB block original signals are sent and in the next SSB block each signal is repeated in the same order of original signals, and
ii. interleaved repetition designs where half of the SSB block includes original SSB signals and the other half includes repeated SSB signals, and other possible extensions.

In one embodiment, SSB repetition information may be conveyed within a master information block (MIB) or a system information block (SIB). The repetition information could be explicitly shared with a field included in the information blocks. Alternatively, the repetition signaling could be implicitly shared by a field or combination of fields that are already present in the information blocks. In one embodiment, the repetition information could be conveyed by the validity of parameters. An example of such parameter setting could be using the k_{SSB} parameter value. The k_{SSB} parameter value will be set to a valid value in an original SSB signal and the k_{SSB} parameter value will be set to an invalid value in a copy SSB signal.

It may be desirable to enable SSB repetition operation while maintaining backwards compatibility. When the SSB repetition is enabled three kinds of UEs should be able to connect to the network. First, the legacy UEs that do not support SSB repetition. Second, the UEs that support SSB repetition and may be experiencing bad channel quality, which may require SSB combining. Third, the UEs that support SSB repetition and may be experiencing good channel quality and can reach the network without SSB combining.

In one embodiment, the legacy UEs can be supported by setting the k_{SSB} parameter value. The k_{SSB} parameter value will be set to a valid value in the original SSB signal. The k_{SSB} parameter value will be set to an invalid value in the copy SSB signal. According to TS 38.211, the UE shall assume the k_{SSB} ∈{0,1,2, . . . , 23}. Therefore, the k_{SSB} parameter value in the copy version, may be set as, for example, 24, 25, . . . etc. If the legacy UE hears the SSB signal copy first, and decodes the invalid k_{SSB} value it can simply discard the detected SSB signal due to this invalid k_{SSB} value. Finally, once the original SSB signal is decoded and a valid k_{SSB} is detected, the legacy UE can continue its initial access procedure.

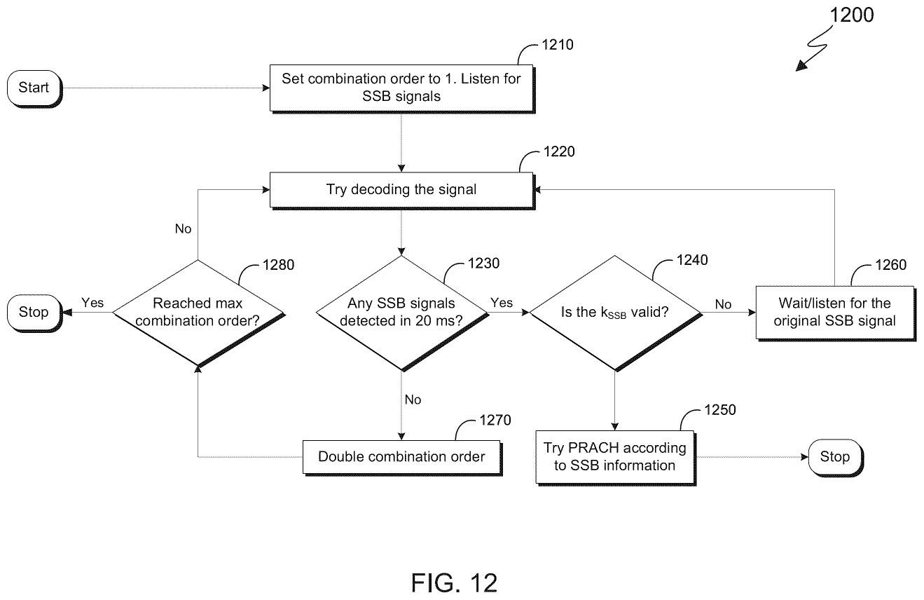

FIG. 12 illustrates an example method 1200 performed by a UE in a wireless communication system according to embodiments of the present disclosure. For example, the method 1200 can be implemented by any of the UEs 111-116 of FIG. 1. This example is for illustration only and can be used without departing from the scope of the present disclosure.

As illustrated in FIG. 12, for UEs that have SSB repetition capability enabled, the method 1200 starts with the UE listening to the channel with a combining order of 1 SSB signal, i.e., no repetition (1210). For example, the UE can assume that the SSB bursts are transmitted every 20 ms, but may use other time intervals in other embodiments. The UE then tries to decode the SSB signal (1220). If the UE can decode any SSB block within 20 ms of listening (1230), the UE can extract the k_{SSB} value and determine whether the value is valid (1240). If the k_{SSB} value is valid, the UE can continue its initial access procedure according to the decoded SSB information (1250). If the k_{SSB} value is invalid, then the UE can wait until the original SSB signal is decoded (1260). Once the original SSB signal is decoded and the k_{SSB} value is assured to be valid, the UE can continue its initial access procedure according to the decoded SSB information.

As further illustrated in FIG. 12, for a UE that have SSB repetition capability enabled, but cannot decode any SSB signals within 20 ms of listening (1230), the UE can increase (e.g., double) its combination order and start power accumulation to combine two SSB blocks in a shifted manner (1270). The UE then determines whether a maximum combination order has been reached (1280) and tries once again to decode the SSB signal (1220). For example, the maximum combination order may be a UE limitation or may be set by the network. If the combined SSB power is strong enough, the UE will be able to decode PSS/SSS signals which will enable frequency and time synchronization for the UE in the initial connection. Afterwards, with the help of PSS/SSS information the UE can decode the PBCH of the first SSB block and determine, based on the k_{SSB} whether the decoded SSB is the original SSB signal. If after 20 ms of listening the UE once again cannot decode any SSB signals (1230), the UE can double the combining order once more (1270). Note that typically, the UE buffer size is limited, and the combination order will be limited by the buffer size. Therefore, each UE could have a max combining order. If the max combining order of the UE has been reached at 1280 and the UE still cannot decode the signal at 1220, the UE may be out of cell coverage.

In one embodiment, the BS could use a fixed SSB repetition order. In other embodiments, the BS can dynamically adjust the SSB repetition order according to KPIs collected from cell sites. KPIs could include, the per UE throughput, reported RSRP values, initial access success probability, initial access delay, initial access success rate, latency, path loss estimate, power constraints, system bandwidth, system carrier frequency, UE throughput, and other indicative metrics.

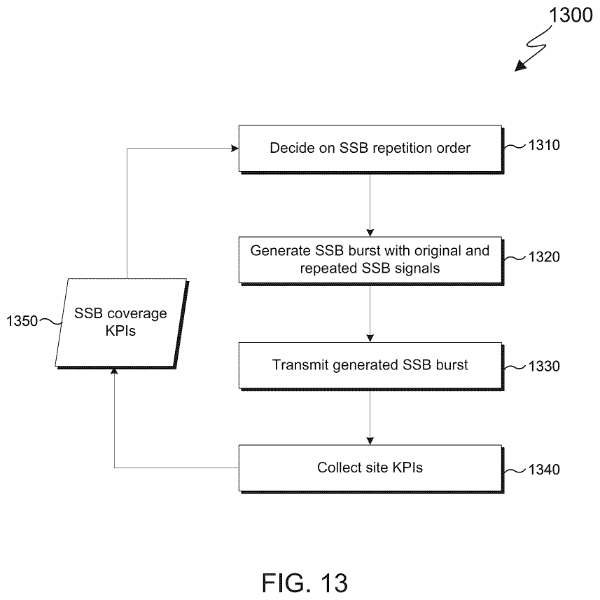

FIG. 13 illustrates an example method 1300 performed by the gNB for dynamically adjusting (i.e., adaptively changing) an SSB repetition order based on cell site KPIs according to embodiments of the present disclosure. For example, the method 1300 can be implemented by the gNB 102 of FIG. 2. This example is for illustration only and can be used without departing from the scope of the present disclosure.

As illustrated in FIG. 13, the method 1300 includes the gNB deciding on an SSB repetition order (1310). In doing so, the gNB generates an SSB burst with both original and a certain number or quantity of repeated SSB signals (1320) and then transmits the generated SSB burst (1330). The gNB then collects cell site KPIs (1340) and based on the SSB coverage KPIs (1350) can decide on updating the SSB repetition order set in 1310.

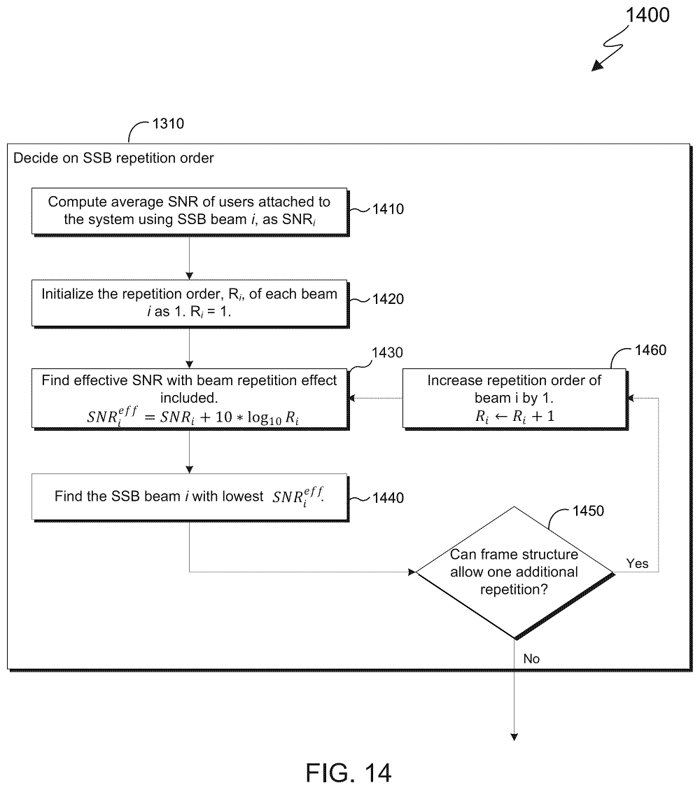

FIG. 14 illustrates an example method 1400 performed by the gNB for how a repetition order can be decided according to embodiments of the present disclosure. For example, the method 1400 can be implemented by the gNB 102 of FIG. 2. This example is for illustration only and can be used without departing from the scope of the present disclosure.

The SSB repetition order could be decided based on various system KPIs. In one example, as illustrated in FIG. 14, the method 1400 begins with the gNB computing an average SNR of users attached to the system using SSB beam i, as SNRᵢ (1410). If the average SNR of users are low, the repetition order could be increased. The repetition order could improve the effective decoding SNR for attached users. To increase the repetition order, the gNB initializes the repetition order, Rᵢ, of each beam i as 1, (Rᵢ=1) (1420). Then, the gNB finds the effective SNR with the beam repetition effect included, (SNRᵢ^{eff}=SNRᵢ+10*log₁₀Rᵢ) (1430). The gNB then finds the SSB beam i with the lowest estimated effective SNRᵢ^{eff}(1440). In one example, a greedy algorithm can be used to select the beam with lowest estimated effective SNRᵢ^{eff}. If the frame structure can allow for one additional repetition (1450), then the gNB can increase the repetition order of beam i by 1 (Rᵢ←Rᵢ+1) to improve the performance of SSB beam with lowest estimated effective SNRᵢ^{eff}(1460). If not, the gNB will generate the SSB burst with the original and repeated SSB signals (1320 of FIG. 13).

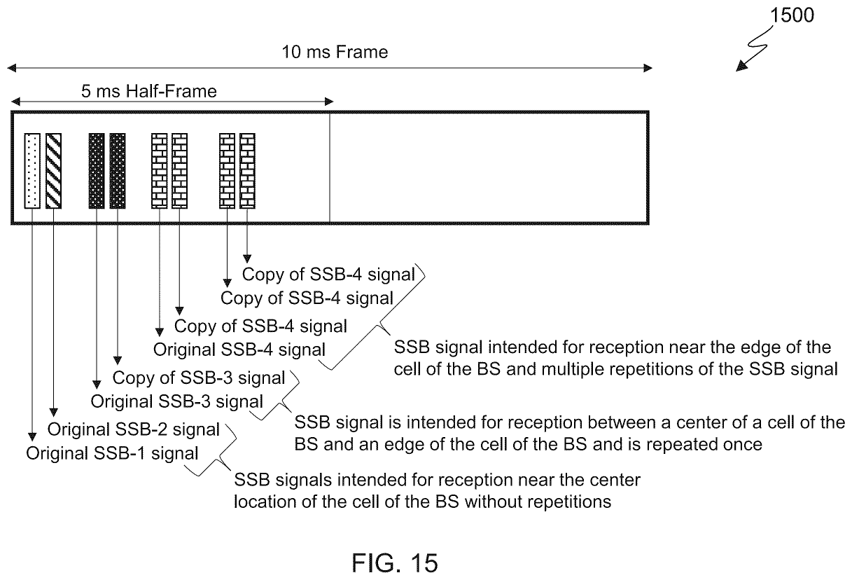

FIG. 15 illustrates an example of an SSB signal repetition order 1500 according to embodiments of the present disclosure. For example, the SSB signal repetition order 1500 can be implemented by the gNB 102 of FIG. 2. This example is for illustration only and can be used without departing from the scope of the present disclosure.

In one embodiment, only a subset of the SSB blocks is repeated. For example, the SSB pointing to or intended for reception at the cell edge may be in repetition mode, while the SSB pointing to or intended for reception at the cell center region may not be repeated.

In another embodiment, the SSB blocks are transmitted with different repetitions. In one option, the number of repetitions is determined by the path loss and/or the beam gain. For instance, the cell edge beams, the cell center beams, and the cell middle beams (i.e., the beams transmitted in area of/intended for reception at the cell between the edge of the cell and the center of the cell) can be repeated a different number of times. For example, the cell edge SSBs could be repeated by 4 times, while the cell middle SSBs could be repeated twice, and the cell center SSBs may not be repeated. In another example, as illustrated in FIG. 15, SSB1 and SSB2 are not repeated, SSB3 is repeated twice, and SSB4 is repeated four times. In various embodiments, for the SSB with narrow beamwidth and higher beam gain, less repetitions may be adopted.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A base station (BS) comprising:
a processor; and
a transceiver operably coupled to the processor, the transceiver configured to transmit, in a synchronization signal block (SSB) burst, a first SSB signal and one or more repetitions of the first SSB signal,
wherein the first SSB signal and the one or more repetitions of the first SSB signal are distinguished based on an indicative signal.

2. The BS of claim 1, wherein the indicative signal is a k_{SSB} parameter included in the first SSB signal and the one or more repetitions of the first SSB signal.

3. The BS of claim 2, wherein:
a valid value for the k_{SSB} parameter indicates that the first SSB signal is an original SSB signal, and
an invalid value for the k_{SSB} parameter indicates that an associated SSB signal is a repetition of the original SSB signal.

4. The BS of claim 1, wherein the indicative signal is transmitted in a master information block (MIB) or a system information block (SIB).

5. The BS of claim 1, wherein the first SSB signal and the one or more repetitions of the first SSB signal are interleaved with at least a second SSB signal and one or more repetitions of the second SSB signal within the SSB burst.

6. The BS of claim 1, wherein:
the transceiver is further configured to receive information associated with key performance indicators (KPIs) from a cell site,
the processor is further configured to determine, based on the KPIs, a quantity of repetitions for the one or more repetitions of the first SSB signal, and
the KPIs are associated with at least one of a reference signal receive power (RSRP), a path loss estimate, a channel estimate, a beam codebook design, a beamforming gain, power constraints, an effective/equivalent isotropically radiated power (EIRP) limit, a system carrier frequency, a system bandwidth, a user equipment throughput, a latency, an initial access success rate, and an initial access delay.

7. The BS of claim 1, wherein:
the first SSB signal is intended for reception between a center of a cell of the BS and an edge of the cell of the BS and is repeated once,
the transceiver is further configured to transmit, in the SSB burst, a second SSB signal intended for reception near the center of the cell of the BS without repetitions, and
the transceiver is further configured to transmit, in the SSB burst, (i) a third SSB signal intended for reception near the edge of the cell of the BS and (ii) multiple repetitions of the third SSB signal.

8. A user equipment (UE) comprising:
a transceiver configured to receive one or more synchronization signal block (SSB) signals; and
a processor operably coupled to the transceiver, the processor configured to determine, based on an indicative signal, whether each of the one or more SSB signals is an original SSB signal or a repetition of the original SSB signal.

9. The UE of claim 8, wherein the indicative signal is a k_{SSB} parameter included in each of the one or more SSB signals.

10. The UE of claim 9, wherein the processor is further configured to:
determine, for a first of the one or more SSB signals, whether a value for the k_{SSB} parameter is valid,
determine that the first SSB signal is the original SSB signal when the value is valid, and
determine that the SSB signal is a repetition of the original SSB signal when the value is invalid.

11. The UE of claim 8, wherein the indicative signal is received via a master information block (MIB) or a system information block (SIB).

12. The UE of claim 8, wherein:
the one or more SSB signals comprise the original SSB signal and the repetition of the original SSB signal at least a second SSB signal and one or more repetitions of the second SSB signal, and
the original SSB signal and the repetition of the original SSB signal are interleaved with at least the second SSB signal and the one or more repetitions of the second SSB signal.

13. The UE of claim 8, wherein:
the one or more SSB signals include the original SSB signal and the repetition of the original SSB signal, and
the processor is further configured to:
combine the original SSB signal and the repetition of the original SSB signal; and
decode the combined SSB signals.

14. A method performed by a base station (BS), the method comprising:
transmitting, in a synchronization signal block (SSB) burst, a first SSB signal and one or more repetitions of the first SSB signal,
wherein the first SSB signal and the one or more repetitions of the first SSB signal are distinguished based on an indicative signal.

15. The method of claim 14, wherein the indicative signal is a k_{SSB} parameter included in the first SSB signal and the one or more repetitions of the first SSB signal.

16. The method of claim 15, wherein:
a valid value for the k_{SSB} parameter indicates that the first SSB signal is an original SSB signal, and
an invalid value for the k_{SSB} parameter indicates that an associated SSB signal is a repetition of the original SSB signal.

17. The method of claim 14, wherein the indicative signal is transmitted in a master information block (MIB) or a system information block (SIB).

18. The method of claim 14, wherein the first SSB signal and the one or more repetitions of the first SSB signal are interleaved with at least a second SSB signal and one or more repetitions of the second SSB signal within the SSB burst.

19. The method of claim 14, further comprising:
receiving information associated with key performance indicators (KPIs) from a cell site; and
determining, based on the KPIs, a quantity of repetitions for the one or more repetitions of the first SSB signal,
wherein the KPIs are associated with at least one of a reference signal receive power (RSRP), a path loss estimate, a channel estimate, a beam codebook design, a beamforming gain, power constraints, an effective/equivalent isotropically radiated power (EIRP) limit, a system carrier frequency, a system bandwidth, a user equipment throughput, a latency, an initial access success rate, and an initial access delay.

20. The method of claim 14, wherein the first SSB signal is intended for reception between a center of a cell of the BS and an edge of the cell of the BS and is repeated once, the method further comprising:
transmitting, in the SSB burst, a second SSB signal intended for reception near the center of the cell of the BS without repetitions; and
transmitting, in the SSB burst, (i) a third SSB signal intended for reception near the edge of the cell of the BS and (ii) multiple repetitions of the third SSB signal.
